(19) United States
(12) Patent Application Publication
(10) Pub. No.: US 2022/0411645 A1
(43) Pub. Date: Dec. 29, 2022

(54) RADIATION CURABLE COATING COMPOSITIONS FOR LIGHT FILTERING

(71) Applicant: Essilor International, Charenton-le-Pont (FR)

(72) Inventors: Robert VALERI, Dallas, TX (US); Haipeng ZHENG, Charenton-le-Pont (FR)

(21) Appl. No.: 17/776,930

(22) PCT Filed: May 10, 2020
(86) PCT No.: PCT/EP2020/063095

§ 371 Date: May 13, 2022

(30) Foreign Application Priority Data
Nov. 21, 2019 (EP) 19306503.4

(51) Int. Cl. C09D 5/32; C09D 163/00; C09D 133/14; C09D 4/00; C09D 11/328; C09D 11/38; C09D 11/102; C09D 11/107; C09D 11/101; C09D 11/037; B05D 3/06; G02B 1/10

(52) U.S. Cl. CPC C09D 5/32; C09D 163/00; C09D 133/14; C09D 4/00; C09D 11/328; C09D 11/38; C09D 11/102; C09D 11/107; C09D 11/101; C09D 11/037; B05D 3/062; G02B 1/10; G02C 7/104

(57) ABSTRACT

The radiation-curable coating compositions disclosed herein are provided for use as photo-stable coatings for an optical article substrate. The compositions may be applied by a variety of methods, including spin coating, dip coating, and inkjet coating. The coating compositions are fast cured and exhibit robust adhesion to the substrates.

### TECHNICAL FIELD

The present disclosure relates to a UV-curable coating composition capable of absorbing or filtering light, to a process for forming a light filter coating using a light filter coating composition, and to an ophthalmic lens having a light filter coating formed by photocuring the light filter coating composition.

### BACKGROUND

Extended exposure of a wearer's eyes to blue light causes eyestrain and damages light-sensitive cells in the retina, which may lead to macular degeneration and permanent vision loss. Ultraviolet (UV) radiation from the sun is a significant cause of damage to such cells. UV radiation can cause sunburn and skin damage that may lead to common skin cancers or even melanomatous skin cancer. Existing eyewear that addresses these issues includes optical article substrates that have a light filtering coating placed in a contacting relationship with a base substrate to provide a blocking layer that protects wearers from UV radiation, blue light, and other types of harmful light.

A number of light-filtering technologies have been developed to filter harmful light to minimize damage to the wearer's eyes. However, one major disadvantage of these technologies is that they are usually designed specifically for certain types of light filtering. Moreover, with the development of multi-layer coating structures on optical article substrates, it is desirable for the first layer of coatings on a substrate to have robust adhesive properties so that they will stay intact relative to the substrate when subsequent coatings are applied. Such properties are especially important for manufacturing methods like inkjet printing, which is now widely used in the optical industry.

Another difficulty encountered in the field is that many ophthalmic lens laboratories use UV curable compositions as coating compositions to improve the adhesion between the coating and the lens substrate. Sometimes the UV curable component must compete with light filters for the light needed for curing, which will ultimately lead to a partially cured product with inferior adhesive properties. Therefore, there remains a clear demand in the industry for an improved method and composition that can be fully cured, and can be applied with all kinds of light filters, while still having robust adhesive properties.

Further, a light filter coating may be formed on the surface of an ophthalmic lens to absorb or block light with certain wavelength. For example, a blue cut filter may be formed on one or both surfaces of a lens to protect wearers' eyes from blue light, and a color filter may be formed on one or both surfaces of a lens to provide desirable color balancing effects to the lens.

Those light filter coatings may be formed by applying a coating composition including a curable resin and a dye onto a lens surface and curing the coating composition. When the coating composition is cured with light, such as ultraviolet (UV) light, the dye may be degraded by the UV irradiation during the curing process, and the obtained coating may have lighter color than the pre-curing composition, or may even have no color. The dye in the obtained coating may also be degraded when the ophthalmic lens with the coating is exposed to the sunlight for a long period of time.

Several attempts have been made to prevent degradation of a dye in a light filter coating composition. A straightforward strategy to maintain the dye's photostability is to add a UV absorber to the light filter coating composition. For example, the application filed under the number EP19306503.4 discloses a radiation curable coating composition for light filtering, including a high amount of UV absorbers.

However, UV absorbers may either add high yellowness to the obtained coating, making the lens very difficult to present high light transmittance and natural color, or cause wrinkles when a relatively thick coating, such as a coating with a thickness over 10 μm, is formed, or decrease the ability of the composition to cure under UV irradiation.

Thus, there is a need for a light filter coating composition having high photostability during a photocuring process, in particular a UV curing process. A light filter coating obtained by photocuring the composition containing an absorbing dye may also have high photostability to sunlight exposure. Another need is for a light filter coating composition having good dye solubility, having long shelf life or pot life, having good adhesiveness to various lens substrates, exhibiting no wrinkle issues when a thick coating is formed, resulting in a hard coating having a high abrasion- and/or scratch-resistance, and having fast curing properties.

### SUMMARY

Hence, an aim of the present disclosure is to provide a desired coating composition comprising epoxy and/or acrylate as the main components to produce a low viscosity formulation that has light filters to block specific wavelength ranges of light. By carefully selecting the appropriate photo-curable chemistry, photoinitiators, and light filters, the resulting coating exhibits robust adhesion and can be applied by various methods including dip, spin, inkjet, etc. to a substrate and that can be fully cured by UV radiation. Such coatings also allow a large variety of chemicals to act as reactive diluents to solubilize different kinds of light filters, and also provide flexibility in adjusting viscosity and other properties.

In some embodiments, the present disclosure is directed to a radiation curable composition comprising at least one light absorber, at least one UV curable resin, and at least one photoinitiator. The at least one UV Curable resin comprises at least one resin selected from the group consisting of an acrylic resin, an epoxy resin, and mixtures thereof.

In some embodiments, the present disclosure is directed to a radiation curable composition comprising:

(a) at least one epoxy monomer having two or three epoxy groups, which is not a silicon compound having at least one hydrolyzable group directly linked to the silicon atom,

(b) optionally, at least one epoxy compound bearing at least one silicon atom having at least one hydrolyzable group directly linked to the silicon atom and at least one group comprising an epoxy function linked to the silicon atom though a carbon atom, and/or a hydrolyzate thereof,

(c) at least one photo-initiator, preferably a cationic photoinitiator,

(d) at least one absorbing dye that at least partially inhibits transmission of light in at least one selected wavelength range included within the 380-780 nm wavelength range, and

(e) at least one antioxidant.

In some embodiments, the present disclosure is directed to a radiation curable composition, preferably a hard coating composition comprising:

(a) at least one epoxy monomer having at least three epoxy groups, preferably at least four epoxy groups and better more than four epoxy groups, which is not a silicon compound having at least one hydrolyzable group directly linked to the silicon atom,

(b) at least one epoxy compound bearing at least one silicon atom having at least one hydrolyzable group directly linked to the silicon atom and at least one group comprising an epoxy function linked to the silicon atom though a carbon atom, and/or a hydrolyzate thereof,

(c) at least one photo-initiator, preferably a cationic photoinitiator

(d) at least one absorbing dye that has a conjugated chromophore and at least partially inhibits transmission of light in at least one selected wavelength range included within the 380-780 nm wavelength range, and

(e) at least one antioxidant, preferably a sterically hindered phenol,

wherein the composition does not comprise any epoxy monomer having two epoxy groups, which is not a silicon compound having at least one hydrolyzable group directly linked to the silicon atom.

Such a composition provides, upon curing, a hard coating having a high abrasion resistance, so that it is not necessary to use inorganic nanoparticles oxides in the composition. Such composition preferably comprises less than 1% by weight of nanoparticles as compared to the weight of the composition, such as nanoparticles of metal oxides, metalloid oxides, nitrides or fluorides.

In some embodiments, the present disclosure is directed to a method for coating a functional coating to an optical article substrate. In some embodiments, the functional coating an optical article with a functional coating, wherein the method comprises providing an optical article, wherein the optical article comprises a substrate having at least one surface; providing a radiation curable coating composition comprising at least one light absorber, at least one UV curable resin, and at least one photoinitiator, wherein the at least one UV curable resin comprises at least one resin selected from the group consisting of an acrylic resin, an epoxy resin, and mixtures thereof; applying the radiation curable coating composition to at least a portion of the at least one surface of the optical article substrate; UV curing the coating applied to the at least one surface of the optical article substrate; and cleaning and preparing the coated surface of the optical article substrate for further treatment.

The step of providing an optical article further comprises providing an optical article, wherein the optical article comprises a substrate having a first surface and a second surface opposed to the first surface. The step of applying the coating further comprises applying the coating composition to at least a portion of the first surface and at least a portion of the second surface. The step of applying further comprises applying the coating composition by at least one process selected from dip-coating, spin-coating, and inkjet-coating.

In yet another embodiment, the present disclosure is directed to an optical article having at least one surface; and at least one functional coating, wherein the functional coating is at least partially in contact with the at least one surface, wherein the coating comprises: at least one light absorber; at least one photoinitiator; and at least one photoinitiator; and the at least one UV curable resin comprises at least one resin selected from the group consisting of an acrylic resin, an epoxy resin, and mixtures thereof.

In one embodiment, the invention relates to a light filter coating composition with a high photostability during UV curing, good dye solubility, and fast curing. A light filter coating obtained by UV curing the light filter coating composition also has good photostability under Q-sun tests and good cosmetic properties, exhibiting no wrinkle issue.

One embodiment of the present disclosure is related to a light filter coating composition. The light filter coating composition includes an absorbing dye capable of at least partially inhibiting transmission of light in at least one wavelength range within a 380 nm to 780 nm range; at least one epoxy compound having preferably at least one of a cycloaliphatic group and an aryl group; an antioxidant additive; and a cationic photoinitiator. The absorbing dye may have a conjugated chromophore. A ratio of a number of carbon atoms to a number of oxygen atoms in the epoxy compound may be 3 or more. A dry extract weight of the at least one epoxy compound may be more than 33% of a dry extract weight of the light filter coating composition. The antioxidant additive may include a sterically hindered phenol. The light filter coating composition may further include a surfactant, a solvent, or both.

Another embodiment of the present disclosure is related to an ophthalmic lens with a light filter coating. Such lens includes: a lens substrate; and a light filter coating obtained by photocuring the light filter coating composition described above.

Another embodiment of the present disclosure is related to eyeglasses having the ophthalmic lens described above.

Another embodiment of the present disclosure is related to a method for forming a light filter coating. The method includes applying the light filter coating composition described above to at least a portion of a first surface of a substrate; and photocuring the light filter coating composition to form a light filter coating. The substrate may be an ophthalmic lens. The photocuring process may be performed by irradiating ultraviolet light to the light filter coating composition applied on the first surface of the substrate. The method may further include applying the light filter coating composition to at least a portion of a second surface of the substrate which is opposite to the first surface, and the light filter coating composition applied to the first and second surfaces of the substrate may be photocured to form the light filter coating on the first and second surfaces.

“Ophthalmic lens” is defined as a lens adapted, namely for mounting in eyeglasses, whose function is to protect the eye and/or to correct vision. This lens can be an afocal, unifocal, bifocal, trifocal, or progressive lens. The ophthalmic lens may be corrective or non-corrective. Eyeglasses wherein ophthalmic lenses will be mounted could be either a traditional frame comprising two distinctive ophthalmic lenses, one for the right eye and one for the left eye, or one ophthalmic lens that simultaneously faces the right and the left eyes, e.g., a mask, visor, helmet sight, or goggle. Ophthalmic lenses may be produced having traditional geometry, such as a circle, or may be produced to be fitted to an intended frame.

Any embodiments of any of the disclosed compositions or methods can “consist of” or “consist essentially of,” rather than comprise, include, contain, or have, any of the described. “Consisting essentially of” can be substituted for any of the open-ended linking verbs recited above, in order to change the scope of a given claim from what it would otherwise be using the open-ended linking verb.

The use of the word “a” or “an” when used in conjunction with the term “comprising” in the claims and the specification may mean “one,” but it is also consistent with the meaning of “one or more,” “at least one,” and “one or more than one.”

As used in this specification and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or methods steps.

The compositions and methods for their use can “comprise,” “consist essentially of,” or “consist of” any of the ingredients or steps disclosed throughout the specification. With respect to the transitional phrase “consisting essentially of,” in one non-limiting aspect, a basic and novel characteristic of the compositions and methods disclosed in this specification includes a UV-curable coating composition that provides robust adhesion to an optical article.

Other objects, features, and advantages of the present disclosure will become apparent from the following detailed description. It should be understood, however, that the detailed description and the examples, while indicating specific embodiments of the invention, are given by way of illustration only. Various substitutions, modifications, additions, and rearrangements will be apparent to those of ordinary skill in the art from this disclosure.

The details of one or more implementations are set forth in the accompanying drawings and the description below. Other features, characteristics, and advantages of the implementations will be apparent from the description.

### DETAILED DESCRIPTION

In the following description, numerous specific details are provided to provide a thorough understanding of the disclosed embodiments. One of ordinary skill in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present disclosure relates to a radiation-curable, light filtering coating composition for optical articles, suitable for forming a light filter coating. In one embodiment, the composition disclosed herein includes at least one light absorber such as an absorbing dye and/or a UV absorber, at least one UV curable resin such as an epoxy compound, and at least one photoinitiator.

In some embodiments, the photoinitiator may be a free radical photoinitiator, cationic photoinitiator, or a combination thereof, preferably a cationic photoinitiator. In some embodiments, the coating composition may include, preferably from 0.5 wt % to 25 wt % of the aforementioned photoinitiators based on the resin content. Such photoinitiators can be selected, for example, from the group consisting of aromatic onium salts, iron arene salt complexes, benzophenone, acetophenone compounds and combinations thereof.

The cationic photoinitiator is not particularly limited, and any cationic photoinitiators that are suitably used in a photocuring an epoxy compound may be used. Examples of the cationic photoinitiator include, but are not limited to a triarylsulfonium salt, a diaryliodonium salt, and mixtures thereof. The triarylsulfonium or diaryliodonium salts may have counter-ions of low nucleophilicity, and may be selected from triarylsulfonium hexafluoroantimonate, triarylsulfonium hexafluorophosphate, diaryliodonium hexafluoroantimonate and diaryliodonium hexafluorophosphate salts. Triarylsulfonium hexafluoroantimonate is available for example from Dow Chemical Company under the trademark CYRACURE™ UVI-6976 (50% by weight in propylene carbonate). Triarylsulfonium hexafluorophosphate is available for example from Dow Chemical Company under the trademark CYRACURE™ UVI-6992 (50% by weight in propylene carbonate). Diaryliodonium hexafluorophosphate is available for example from Ciba Specialty Chemicals, under the reference IRG-250, or from Aldrich under the reference 548014. Diaryliodonium hexafluoroantimonate is available for example from Sartomer Company under the reference SarCat CD 1012.

In one embodiment, a mixture of two triarylsulfonium salts is used, preferably a mixture of triarylsulfonium hexafluoroantimonate and triarylsulfonium hexafluorophosphate.

The cationic photo initiator and/or free radical photo initiator catalyzes the polymerization of the epoxy functional monomers and the condensation of the alkoxysilane groups. In particular, when triarylsulfonium salt is used, the triarylsulfonium salt will cleave upon photolysis and produce an aryl radical and a diarylsulfonium cation-radical (see J. V. Crivello, D. A. Conlon, and J. L. Lee, “The Synthesis and Characterization of Cationic Photoinitiators Bearing Two and Three Photoactive Triarylsulfonium Groups in the Same Molecule”, Polymer Bulletin 14, 279-286 (1985)). The diarylsulfonium cation-radical then generates, in subsequent reactions, strong Bronsted acids which initiate the cationic polymerization (epoxy ring opening) of the epoxy-functional monomers and simultaneously catalyze the hydrolysis and condensation of the alkoxysilane groups (sol-gel process) using atmospheric moisture during the photolysis.

A dry extract weight of the cationic photoinitiator may be from 1.5% by weight to 3% by weight, for example 2% by weight to 2.5% by weight, of a dry extract weight of the light filter coating composition.

In some embodiments, the at least one resin is an acrylic resin, and the acrylic resin is the sole resin of the at least one UV curable resin. In yet another embodiment, the at least one resin is an epoxy resin, and the epoxy resin is the sole resin of the at least one UV curable resin. In yet another embodiment, an acrylic resin and an epoxy resin may be jointly present in the UV curable resin. In some embodiments, the coating composition may include solely an acrylic resin, preferably from 68 wt % to 99 wt %, in the UV curable resin. In other embodiments, the coating composition may include solely an epoxy resin, preferably from 68 wt % to 99 wt %, in the UV curable resin. In yet another embodiment, the coating composition may include at least one resin, and more particularly, and wherein the at least one resin is a mixture of the acrylic resin and the epoxy resin, and wherein the mixture is the sole resin of the at last one UV curable resin. The mixture of the acrylic resin and the epoxy resin comprises from 1 wt % to 98 wt % of acrylic resin and from 1 wt % to 98 wt % of epoxy resin. In the present disclosure, the term “resin” includes resin precursors such as monomers and oligomers. The at least one resin is preferably selected from the group consisting of mono-to hexaacrylate monomers, mono-to diacrylate oligomers, cycloaliphatic epoxies, mono-to polyglycidylether epoxies, and combinations thereof.

In one embodiment, the resin comprises at least one epoxy compound. The epoxy compound may be an epoxy monomer. Examples of the epoxy monomer include, but are not limited to, glycidoxypropyltrimethoxysilane (GLYMO), ethylene glycol diglycol ether (DEDGE), trimethylolpropane triglycidyl ether (such as Erisys® GE-30), trimethylolethane triglycidyl ether (such as Erisys® GE-31), sorbitol polyglycidyl ether (such as Erisys® GE-60, which is a tetraglycidyl ether), 3,4-epoxycyclohexyl-methyl-3,4-epoxycyclohexane carboxylate (such as UVACURE® 1500 or UVR-6110), 1,1,1-tris-(p-hydroxyphenyl) ethane glycidyl ether (such as Epalloy® 9000), bisphenol A diglycidyl ether (such as EPON® 828), resorcinol diglycidyl ether (RDGE), and epoxycyclohexyl POSS® Cage Mixture (EP0408). These epoxy monomers may be used alone or in combination.

In one embodiment, the epoxy compound comprises at least three epoxy groups, more preferably at least four, six or eight epoxy groups, and is preferably not is not a silicon compound having at least one hydrolyzable group directly linked to the silicon atom. It has been found by the inventors that using such highly functional epoxy compounds promotes abrasion resistance of the resulting coating.

In one embodiment, the epoxy compound may have a cycloaliphatic group, an aryl group, or both. Among the examples of epoxy monomer described above, 3,4-epoxycyclohexyl-methyl-3,4-epoxycyclohexane carboxylate, 1,1,1-tris-(p-hydroxyphenyl) ethane glycidyl ether, bisphenol A diglycidyl ether, resorcinol diglycidyl ether, and EP0108 have a cycloaliphatic group or an aryl group. The epoxy compound may be a combination of an epoxy monomer having a cycloaliphatic group and/or an aryl group, and an epoxy monomer not having a cycloaliphatic group and/or an aryl group. When an epoxy monomer having a cycloaliphatic group and/or an aryl group and an epoxy monomer not having a cycloaliphatic group and/or an aryl group are used in combination, the amount of the epoxy monomer having a cycloaliphatic group and/or an aryl group may be greater than the amount of the epoxy monomer not having a cycloaliphatic group and/or an aryl group.

In one embodiment, the epoxy compound has carbon atoms and oxygen atoms so that a ratio of a number of carbon atoms to a number of oxygen atoms is 3 or more. Among the examples of epoxy monomer described above, 3,4-epoxycyclohexyl-methyl-3,4-epoxycyclohexane carboxylate (O:C=1:3.5), 1,1,1-tris-(p-hydroxyphenyl) ethane glycidyl ether (O:C=1:4.8), bisphenol A diglycidyl ether (O:C=1:5.75), resorcinol diglycidyl ether (O:C=:3.5), and EP0108 (O:C=1:3.2) have the oxygen-to-carbon number ratio of 3 or more. In contrast, ethylene glycol diglycol ether (O:C=1:2), trimethylolpropane triglycidyl ether (O:C=1:2.5), and sorbitol polyglycidyl ether (O:C=1:2) have the oxygen-to-carbon number ratio of less than 3.

In one embodiment, the composition does not comprise any epoxy monomer having two epoxy groups, which is not a silicon compound having at least one hydrolyzable group directly linked to the silicon atom. When such compounds are absent or present in a low amount (e.g., the commercial compound UVACURE 1500), the abrasion resistance of the corresponding coating is increased. In fact, using tri- or multi-functional epoxy compounds rather than diepoxy compounds improves the UV curable coatings' abrasion and/or scratch resistance even without the addition of inorganic nanoparticles. Alternatively, the composition comprises less than 1% by weight of epoxy monomers having two epoxy groups, which are not silicon compounds having at least one hydrolyzable group directly linked to the silicon atom, as compared to the total weight of the composition. In the present application, oligomers are considered as being monomers.

In one embodiment, the composition comprises at least one epoxy compound (b) bearing at least one silicon atom having at least one hydrolyzable group directly linked to the silicon atom and at least one group comprising an epoxy function linked to the silicon atom though a carbon atom, and/or a hydrolyzate thereof, such as Glymo. In one embodiment, the dry extract weight of such epoxy compounds (b) represents 40 to 70% of the dry extract weight of the composition, more preferable 50 to 60%. In this way, the hardness of the resulting coating can be improved. In another embodiment, such epoxy compounds (b) represent more than 50% by weight as compared to the total weight of polymerizable compounds present in the composition.

In one embodiment, the at least one resin is at least one epoxy monomer having two or three epoxy groups, which is not a silicon compound having at least one hydrolyzable group directly linked to the silicon atom, such as the commercial compounds UVACURE 1500 or Erisys GE-31. In the present application, Si—O—Si groups are considered as not being hydrolyzable groups.

The amount of the epoxy compound in the light filter coating composition may be from 30 to 60% by weight, for example 35 to 55% by weight, including all ranges and subranges therebetween. In one embodiment, the amount of the epoxy compound in the light filter coating composition may be adjusted so that a dry extract weight of the epoxy compound is more than 33%, for example more than 50% or more than 60%, of a dry extract weight of the light filter coating composition. In one embodiment, a dry extract weight of the epoxy monomer having a cycloaliphatic group and/or an aryl group may be more than 33%, for example more than 50% or more than 60%, of a dry extract weight of the light filter coating composition. Here, the “dry extract weight” of a certain component of the composition represents the content of this compound in the final coating, and the “dry extract weight of the light filter coating composition” means a total solid amount of the light filter coating composition.

The dry extract weight can be calculated as a theoretical dry extract weight as disclosed in US 2012/0295084 or EP 614957. Typically, it is, for a hydrolyzable silane compound, the calculated weight as expressed in QkSiO(4−k)/2 units wherein Q is an organic moiety directly bound to the silicon atom through a Si—C bond, k is 0, 1, 2 or 3, and QkSiO(4−k)/2 results from the hydrolysis of QkSiR″′(4−k) where Si—R″′ gives Si—OH upon hydrolysis.

The dry extract weight can also be determined experimentally such as described in WO 2018/178106.

When the light filter coating composition includes an epoxy compound and/or an acrylic compound, these compounds may be polymerized upon irradiation with light, such as UV light. When the light filter coating composition includes an acrylic compound, the light filter coating composition may further include a radical photoinitiator to initiate polymerization of the acrylic compound upon irradiation with light, such as UV light. In some embodiments, the light filter coating composition may be free of an acrylic resin (acrylate compounds) and a radical photoinitiator.

In some embodiments, the coating composition may comprise at least one light absorber to filter harmful lights of specific wavelengths. The light absorber/dye can include, for example, UV light absorbers (for light in a wavelength range of 200 nm-400 nm), blue light absorbers (capable of absorbing light in a wavelength range of 400 nm-500 nm, or capable of absorbing light for all blue light wavelengths with the high energy blue light related to eye light damage such as the 415 nm-455 nm range), infrared absorbers (for light in a wavelength range of 700 nm-1 mm), or any suitable light absorbers. The light absorber in the coating composition is preferably a UV light absorber or a visible light absorber such as an absorbing dye.

The absorbing dye is a dye capable of at least partially inhibiting transmission of light in at least one wavelength range within a 380 nm to 780 nm range. The wavelength range within the 380 nm to 780 nm range may be a visible light wavelength range. In one embodiment, the absorbing dye may be a dye capable of absorbing or inhibiting transmission of blue light, or a color filtering dye having a certain color, such as blue or red.

Examples of the absorbing dye include, but are not limited to, a red dye such as ABS420®, and a blue dye such as Savinyl® Blue (Solvent Blue 45). The absorbing dye may have a conjugated chromophore.

Although not limited in any way, the absorbing dye may be degraded and exhibit no color or lighter color after being exposed to ultraviolet (UV) light for a certain period of time, for example 2 minutes or more.

The light filter coating composition may include a sufficient amount of the absorbing dye to provide suitable color to a light filter coating obtained by curing the light filter coating composition, and/or to provide a satisfactory inhibition of light within the 380-780 nm wavelength range. In one embodiment, the light filter coating composition includes 0.01% by weight to 1% by weight, for example 0.02% by weight to 0.5% by weight based on the weight of the coating composition, of the absorbing dye, including all ranges and subranges therebetween, depending on the strength of the dye and the amount of inhibition/protection desired.

In one embodiment, the light filter coating composition is free of a UV light absorber and/or an infrared absorber. In one embodiment, the light filter coating composition includes no more than 0.5% by weight a UV light absorber.

In one embodiment, the composition comprises at least one antioxidant additive, which generally imparts protection against thermal oxidation, and any antioxidants that are suitably used in a photocurable composition may be used. The antioxidant also protects the absorbing dye from photodegradation.

Preferred antioxidants are sterically hindered phenols, thioethers or phosphites, preferably sterically hindered phenols. They are commercially available from BASF under the trade names Irganox® and Irgafos®.

Examples of the antioxidant additive include, but are not limited to, ethylene bis(oxyethylene) bis-(3-(5-tert-butyl-4-hydroxy-m-tolyl)-propionate) (Irganox® 245), pentaerythritol tetrakis[3-[3,5-di-tert-butyl-4-hydroxyphenyl]propionate (Irganox® 1010), octadecyl-3-[3,5-di-tert-butyl-4-hydroxyphenyl]propionate](Irganox® 1076), and N,N′-1,6-hexanediylbis[3,5-bis(1,1-dimethylethyl)-4-hydroxyphenylpropanamide](Irganox® 1089).

The amount of the antioxidant additive in the light filter coating composition may be at least 1% by weight, or from 1% by weight to 3% by weight, for example 1.4% by weight to 2.5% by weight, including all ranges and subranges therebetween. A dry extract weight of the antioxidant additive may be from 2% by weight to 6% by weight, for example 2.9% by weight to 5.1% by weight, of a dry extract weight of the light filter coating composition, including all ranges and subranges therebetween.

In some embodiments, the coating composition comprises at least one hindered amine light stabilizer (HALS), which protects against photo-degradation.

Preferably, the coating composition comprises at least one hindered amine light stabilizer, and/or at least one antioxidant, more preferably at least one hindered amine light stabilizer and at least one antioxidant. This combination of free radical scavengers offers the best protection from thermal and photo degradation to dyes.

In one embodiment, the free radical scavenger is a sterically hindered phenol or amine.

Preferred hindered amine light stabilizers are derivatives of piperidine, such as derivatives of 2,2,6,6-tetramethyl piperidine. They are commercially available from BASF under the trade names Tinuvin® and Chimassorb®, such as 2,4-bis[N-butyl-N-(1-cyclohexyloxy-2,2,6,6-tetramethylpiperidin-4-yl)amino]-6-(2-hydroxyethylamine)-1,3,5-triazine (Tinuvin® 152 from BASF),

In some embodiments, the coating composition may further comprise at least one solvent. Such solvent can be selected from, for example, 1-methoxy-2-propanol (such as Dowanol PM) or ethyl acetate.

In some embodiments, the coating composition comprises at least one surfactant. The surfactant can include, for example, poly(alkylene glycol)-modified polydimethylsiloxanes or polyheptamethylsiloxanes, or fluorocarbon-modified polysiloxanes. Preferred surfactants are fluorinated surfactants such as Novec® FC-4434 from 3M (non-ionic surfactant comprising fluoroaliphatic polymeric esters), Unidyne™ NS-9013, and EFKA® 3034 from CIBA (fluorocarbon-modified polysiloxane).

The coating composition may be prepared by mixing all components, including for example an absorbing dye, one or more epoxy compounds, an antioxidant additive, and a cationic photoinitiator. The order of mixing the components is not particularly limited. When the coating composition includes a solvent, all components other than the solvent and the absorbing dye may be mixed, and then the solvent and the absorbing dye may be added to the mixture at the same time or different times. In one embodiment, a base coating composition including all components other than the absorbing dye may be prepared, and the absorbing dye may be added to the base coating composition and mixed just prior to use.

In some embodiments, the coating composition may have a viscosity from 8 cps to 20 cps at 25 degrees Celsius, a surface tension from 32 dynes to 42 dynes, a particle size no larger than 0.20 microns, and a pH from 4 to 9.

The present disclosure also relates to a method for coating an optical article with a functional coating, and forming a light filter coating on a substrate, wherein the method comprises: providing an optical article, wherein the optical article comprises a substrate having at least one surface; providing a radiation curable coating composition comprising at least one light absorber, at least one UV curable resin, and at least one photoinitiator, wherein the at least one UV curable resin comprises at least one resin selected from the group consisting of an acrylic resin, an epoxy resin, and mixtures thereof; applying the radiation curable coating composition to at least a portion of the at least one surface of the optical article substrate; UV curing the coating applied to the at least one surface of the optical article substrate; and cleaning and preparing the coated surface of the optical article substrate for further treatment.

In some embodiments, the light absorbers may be UV absorbers, blue light absorbers, infrared absorbers, or any suitable light absorbers that may be used on the optical substrate. The light absorbers may compete with the photoinitiator for the light needed for radiation curing. In this case, full curing is achieved by careful selection of specific photoinitiators and their concentration so that they can be activated by wavelengths of light not absorbed by the selected light absorber.

In one embodiment, the composition comprises 0% or less than 0.5% by weight of UV absorbers, as compared to the weight of the composition, and/or the dry extract weight of UV absorbers represents less than 1% of the dry extract weight of the composition. Using a too high amount of UV absorber may be detrimental to the polymerization reaction under UV irradiation. In this case, the composition can be fully polymerized by UV irradiation in curing step (d), and does not require any final thermal curing.

In step (c) of the method of the present disclosure, at least a portion of an optical article substrate is coated with the composition described above. The coating solution may be coated using, for example, spin-coating, dip-coating, or inkjet-coating, onto the surface of the optical article substrate. The substrate may be selected from the group consisting of, but not limited to, polycarbonates, polyamides, polyimides, polysulfones, copolymers of polyethylene therephthalate and polycarbonate, polyolefins such as polynorbornenes, resins resulting from polymerization or (co)polymerization of alkylene glycol bis allyl carbonates such as polymers and copolymers of diethylene glycol bis(allycarbonate) (marketed, for instance, under the trade name CR-39® by the PPG Industries company), polycarbonates such as those derived from bisphenol A, (meth)acrylic or thio(meth)acrylic polymers and copolymers such as polymethyl methacrylate (PMMA), urethane and thiourethane polymers and copolymers, epoxy polymers and copolymers, episufide polymers and copolymers. In some embodiments, the optical article may be an ophthalmic lens that comprises photochromic materials.

After coating the optical substrate, the resulting substrate coated with the coating composition is irradiated with light, in particular UV light, including UVA, UVB, and UVC. The curing step (d) comprises irradiating the coated layer with a UV radiation dosage ranging preferably from 0.5 J/cm² to 4.5 J/cm² in the UV range 200 nm to 440 nm. In step (d), the at least one photoinitiator, for example the cationic photoinitiator(s) and free radical photoinitiator(s) are used to initiate the polymerization of the acrylic functional monomer, and/or, initiate the polymerization of the epoxy functional monomer and promote the hydrolysis and condensation of the alkoxy groups of the alkoxysilane. The resulting products will have a strong cross-linked network and thereby exhibit robust adhesion to the substrate.

In some embodiments, the method disclosed herein may optionally comprise a thermal curing step after the curing step (d), especially when a solvent has been used to solubilize the UV curable resin, for example a thermal treatment at 100° C. for two hours or 125° C. for one hour.

In some embodiments, the method may further comprise steps for subsequent treatments or coatings. Because of the robust adhesion from a well-cured coating composition, the adhered coatings are able to withstand stripping and cleaning lines during application of subsequent treatments/coatings. In some embodiments, the optical article substrate may be further treated for example with a caustic treatment, or a plasma treatment. The additional coating process may include, for example, UV blocking coating, primer coating, abrasion resistant coating, anti-reflective coating, hydrophobic topcoating, or a combination thereof. These treatments and/or coating processes may be combined in any order

In some embodiments, the light absorbers such as dyes in the coating composition are deposited onto the optical substrate in a way that exhibits a thickness gradient across the surface of the optical article substrate, i.e., so that the amount thereof gradually increases or decreases across the surface of the optical article substrate, while the overall coating has a uniform thickness across the surface of the optical article substrate. Such thickness gradient of light absorbers can be achieved for example, by dip-coating, spin-coating, inkjet-coating, or any suitable coating techniques. Consequently, this could be a method of creating a gradient photochromic lens, if applied to a stock photochromic lens by blocking the wavelengths of light that activate the photochromic compound to different degrees. In this particular type of application, it is advantageous to apply a UV absorbing layer to the other side of the lens to prevent light from entering and activating the photochromic compound from that side.

Another aspect of the present disclosure is related to an ophthalmic lens having a light filter coating.

The ophthalmic lens with a light filter coating may include a lens substrate, and a light filter coating obtained by photocuring the light filter coating composition described above. The light filter coating may be obtained by curing the light filter coating composition with UV light, including UVA, UVB, and UVC.

The light filter coating may be formed on one surface, or both surfaces, of the lens substrate.

The light filter coating may have a thickness of less than 10 μm. In some embodiments, the light filter coating may have a thickness of 10 μm or more.

Another aspect of the present disclosure is related to eyeglasses having the ophthalmic lens described above. The eyeglasses may be sunglasses.

The present disclosure also relates to an optical article coated with the coating composition and method described above. In some embodiments, the described coatings may be applied to both sides of the optical article. This is important in the case of a photochromic ophthalmic lens. Application of such a composition to such substrates would result in a gradient photochromic lens upon light activation, and if only one side is coated, some light might enter the lens through the other side, thereby reducing or eliminating the gradient effect.

As used herein, a coating that is “on” a substrate/coating or which has been deposited “onto” a substrate/coating is defined as a coating that (i) is positioned above the substrate/coating, (ii) is not necessarily in contact with the substrate/coating, that is to say one or more intermediate coating(s) may be interleaved between the substrate/coating and the relevant coating (however, it does preferably contact said substrate/coating), and (iii) does not necessarily completely cover the substrate/coating. When a first coating is said to be located under a second coating, it should be understood that the second coating is more distant from the substrate than the first coating.

### EXAMPLES

The following examples are illustrative and do not limit in any way the present embodiments.

### Tests

### Simulated Aging

The examples described below were subjected to the Q-sun test to stimulate the effects of sunlight exposure upon the coated optical articles. The Q-sun test consists of placing the coated optical articles in a Q-sun® Xe-3 xenon chamber, which reproduces full spectrum sunlight, at a relative humidity of 20% (±5%) and at a temperature of 23° C. (±5° C.), and exposing their coated sides to the light for 40 to 80 hours.

### UV Block Performance

The UV blocking performance of each example was evaluated by using a Cary 50 spectrophotometer when exposing the convex side of the lens to bright sunlight and then visually evaluating the degree of attenuation of the photochromic by the UV absorber in the coating.

Abrasion resistance was determined as disclosed in WO 2012/173596. Specifically, abrasion resistance was measured by means of the sand Bayer test, in accordance with the ASTM F735-81 standard, 1 week after production of the article.

Haze was measured on a Haze-Gard XL-211 Plus apparatus from BYK-Gardner in accordance with the standard ASTM D1003-00. As haze is a measurement of the percentage of transmitted light scattered more than 2.5° from the axis of the incident light, the smaller the haze value, the lower the degree of cloudiness. Generally, for optical articles described herein, a haze value of less than or equal to 0.3% is acceptable, more preferably of less than or equal to 0.2%.

### Hard Coating First Pass

A solvent-borne hard coating is applied to lenses after the lenses are treated with a heated caustic solution. The hard-coated lens is then exposed to a high temperature post-cure. The desirable products must not exhibit any hazing, orange peel, or coating loss through this process. The coated lens is re-tested with the Cary 50 spectrophotometer to be sure that there was no UV absorber loss or loss of UV blocking performance due to the coating process.

### Hard Coating Second Pass

The coated semi-finished lens must be able to withstand further heated caustic to strip off the applied hard coating without affecting the coating composition. The lenses need to undergo a second pass through the coating line to apply the solvent-borne hard coating. Afterward, all performances are evaluated with the Cary 50 spectrophotometer.

### Surfacing

The surfacing of semi-finished (“SF”) lenses to Rx prescription lenses requires the application of surface saver tape to the coated convex side of the lens, followed by application of a metal alloy or hot wax blocking material to the surface saver tape. The blocked lens is then placed into a surfacing machine that grinds the concave side of the lens to the desired Rx prescription curve. The surfaced concave side is subsequently polished and the metal alloy or wax block is removed along with the surface saver tapes. If there is any removal of the coating during this process, the coating would be deemed as a failure regarding adhesive properties of the coating.

Examples 1-3 include exemplary coating compositions that are applied to an optical article substrate using the technique of inkjet-coating. Inkjet printers require the coating composition to have certain properties in order to produce desirable products, for example, a popular industrial inkjet printer requires that the viscosity of coating compositions at 25° C. need to be in the range from 8 cps to 20 cps, etc. The detailed specification required is listed in Table 1. Different inkjet printers and nozzles have different specifications. These specifications are for the specific printer used by Transitions.

TABLE 1
Ink Jet Properties Specifications

| Ink Jet Properties Specifications | Range | |
|---|---|---|
| Viscosity (cps @ 25° C.) | 8 to 20 | cps |
| Surface Tension | 32 to 42 | dynes |
| Boiling Point | >100° | C. |
| Specific Gravity | >1.00 | |
| Maximum particle size | 0.20 | microns |

| | |
|---|---|
| pH | 4-9 |

### Example 1

An optical article was prepared with an epoxy/acrylic hybrid coating. 1, 4-butanediol diacrylate was used to lower the viscosity and dissolve the light (UV) absorber. Example 1 also included fluoroaliphatic polymeric esters in dipropylene glycol monomethyl ether as the surfactant. Since Example 1 does not contain any solvent, thermally curing is not needed for full curing. The composition of Example 1 is listed below.

TABLE 2
Example 1, Epoxy/Acrylic hybrid composition and component functions

| | | % by | |
|---|---|---|---|
| Component | Chemical Name | weight | Function in coating |
| Eusorb UV-1990 | UV absorber (Trade Secret) | 3.00 | Light absorber |
| UVR-6110 | 3,4-epoxycyclohexane-3,4- | 39.10 | Epoxy for adhesion |
| | epoxycyclohexyl-methyl carboxylate | | and caustic |
| GE-31 | Trimethylolethane triglycidylether | 15.00 | resistance |
| SR-213 | 1,4-butanediol diacrylate | 34.69 | Reactive diluent |
| UVI-6976 | triarylsulfonium | 4.050 | Photoinitiator |
| | hexafluoroantimonate | | |
| UVI-6992 | triarylsulfonium hexafluorophosphate | 1.35 | Photoinitiator |
| Darocur 1173 | 2-Hydroxy-2-methyl-1-phenyl- | 2.24 | Photoinitiator |
| | propan-1-one | | |
| Irgacure 819 | Bis (2,4,6-trimethylbenzoyl) - | 0.56 | Photoinitiator |
| | Phenylphosphineoxide | | |
| FC4434 | 25% fluoroaliphatic polymeric esters | 0.10 | Surfactant |
| | in dipropylene glycol monomethyl | | |
| | ether | | |

### Example 2

An optical article was prepared with a solvent-borne purely epoxy coating, and the solvents Dowanol PM and ethyl acetate were used to lower the viscosity and dissolve the light (UV) absorber. Similar to Example 1, Example 2 also included fluoroaliphatic polymeric esters in dipropylene glycol monomethyl ether as the surfactant. In example 2, thermally curing may be necessary to remove the solvent content in the coating. The composition of Example 2 is listed below.

TABLE 3
Example 2, pure epoxy composition and component functions

| | | % by | |
|---|---|---|---|
| Component | Chemical Name | weight | Function in coating |
| Eusorb UV-1990 | UV absorber (Trade Secret) | 2.11 | Light absorber |
| Dowanol PM | 1-methoxy-2-propanol | 20.56 | Solvent |
| Ethyl Acetate | Trimethylolethane triglycidylether | 8.81 | Solvent |
| UVR-6110 | 3,4-epoxycyclohexane-3,4- | 44.86 | Epoxy for adhesion |
| | epoxycyclohexyl-methyl carboxylate | | and caustic |
| GE-31 | Trimethyloethane triglycidylether | 17.24 | resistance |
| UVI-6976 | triarylsulfonium | 4.72 | Photoinitiator |
| | hexafluoroantimonate | | |
| UVI-6992 | triarylsulfonium hexafluorophosphate | 1.57 | Photoinitiator |
| FC4434 | 25% fluoroaliphatic polymeric esters | 0.14 | Surfactant |
| | in dipropylene glycol monomethyl | | |
| | ether | | |

### Example 3

An optical article was prepared as an epoxy/acrylic hybrid coating with phenoxyethyl acrylate used to lower the viscosity and dissolve the light (UV) absorber. Similar to Example 1, Example 3 also included fluoroaliphatic polymeric esters in dipropylene glycol monomethyl ether as the surfactant. Since Example 3 does not contain any solvent, thermal curing is not needed for full curing. The composition of Example 3 is listed below.

TABLE 4
Example 3, pure acrylic composition and component functions

| | | % by | |
|---|---|---|---|
| Component | Chemical Name | weight | Function in coating |
| Eusorb UV-1990 | UV absorber (Trade Secret) | 3.00 | Light absorber |
| SR-339 | Phenoxyethyl acrylate | 48.57 | Reactive diluent |
| SR-399 | Dipentaerythritol pentaacrylate | 15.06 | Good solvent |
| | | | resistance |
| CN2261 | Polyester acrylate oligomer | 29.14 | Adhesion and solvent |
| | | | resistance |
| Darocur 1173 | 2-Hydroxy-2-methyl-1-phenyl- | 3.30 | Photoinitiator |
| | propan-1-one | | |
| Irgacure 819 | Bis (2,4,6-trimethylbenzoyl) - | 0.83 | Photoinitiator |
| | Phenylphosphineoxide | | |
| FC4434 | 25% fluoroaliphatic polymeric esters | 0.10 | Surfactant |
| | in dipropylene glycol monomethyl | | |
| | ether | | |

Table 5 below shows the adhesive performance of examples 1-3. The coatings exhibit robust adhesion to optical article substrates in all tests.

TABLE 5
Adhesive performance tests of Examples 1-3

| | Pure Epoxy | Pure Acrylic | Epoxy/Acrylic |
|---|---|---|---|
| Test | Composition | Composition | Hybrid |
| Primary (Dry) | Pass | Pass | Pass |
| Adhesion | | | |
| Hardcoating 1^{st} | Pass | Pass | Pass |
| pass/2^{nd} pass | | | |
| Simulated Aging | Pass 80 hours | Pass 80 hours | Pass 80 hours |
| UV block after | Excellent | Excellent | Excellent |
| Hardcoating | | | |
| Caustic Resistance | Excellent | Excellent | Excellent |

The following examples 1A to 6A relate to radiation curable compositions containing a blue light absorbing dye and an antioxidant, providing photostable coatings.

### (1) Preparation of Base Coating Compositions

Table 1 below summarizes materials used to prepare base coating compositions in examples 1A to 6A and 1B to 10 B:

TABLE 6

| Commercial name/supplier | Chemical name | Function |
|---|---|---|
| UVACURE 1500 | 3,4-epoxycyclohexyl-methyl-3,4 - | Epoxy compound |
| | epoxycyclohexane carboxylate | |
| Erisys GE-31 | Trimethylolethane triglycidyl ether | Epoxy compound |
| Erisys GE-60 | Sorbitol polyglycidyl ether | Epoxy compound |
| Glymo from Evonik | Glycidoxypropyltrimethoxysilane | Epoxy compound |
| Cyracure UVI-6976 from Dow Chemical | Triarylsulfonium | Cationic |
| | hexafluorophosphate | photoinitiator |
| Cyracure UVI-6992 from Dow Chemical | Triarylsulfonium | Cationic |
| | hexafluoroantimonate | photoinitiator |
| Irganox 245 | Ethylene bis (oxyethylene) bis-(3-(5- | Antioxidant |
| | tert-butyl-4-hydroxy-m-tolyl)- | additive |
| | propionate) | |
| Tinuvin 1130 from BASF | Hydroxyphenyl benzotriazole | UV absorber |
| Dowanol PM from Dow Chemical | 1-methoxy-2-propanol | Solvent |
| FC-4434 from 3M | Fluorocarbon modified siloxane | Surfactant |
| | surfactant | |
| Tinuvin 152 from BASF | 2,4-bis[N-butyl-N-(1-cyclohexyloxy- | HALS |
| | 2,2,6,6-tetramethylpiperidin-4- | |
| | yl)amino]-6-(2-hydroxyethylamine)- | |
| | 1,3,5-triazine | |
| EP3F08.01 (70% EP0408/30% | Octaepoxycyclohexyl cage | Epoxy compound |
| propylene glycol methyl ether acetate) | compound | |
| from Hybrid Plastics | | |
| Epalloy 9000 from CVC Specialty | 1,1,1-tris-(p-hydroxy phenyl) ethane | Epoxy compound |
| Chemicals | triglycidyl ether | |
| EP0409 (CAS: 68611-45-0) | octaglycidyl ether cage compound | Epoxy compound |

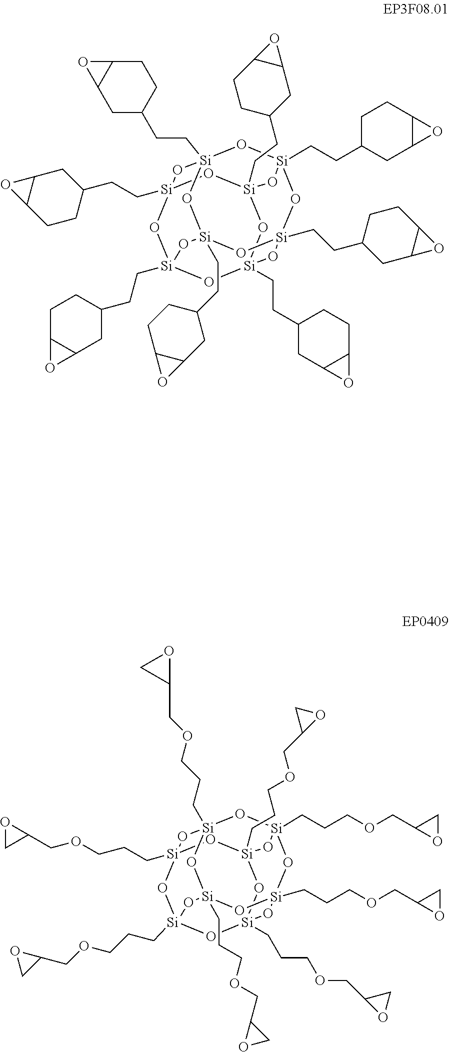 [SMILES: C1CC2OC2CC1CC[Si]12O[Si]3(CCC4CCC5OC5C4)O[Si]4(CCC5CCC6OC6C5)O[Si](CCC5CCC6OC6C5)(O1)O[Si]1(CCC5CCC6OC6C5)O[Si](CCC5CCC6OC6C5)(O2)O[Si](CCC2CCC5OC5C2)(O3)O[Si](CCC2CCC3OC3C2)(O4)O1 ; C(COCC1CO1)C[Si]12O[Si]3(CCCOCC4CO4)O[Si]4(CCCOCC5CO5)O[Si](CCCOCC5CO5)(O1)O[Si]1(CCCOCC5CO5)O[Si](CCCOCC5CO5)(O2)O[Si](CCCOCC2CO2)(O3)O[Si](CCCOCC2CO2)(O4)O1]

### Examples 1A to 6A

Base coating compositions of Examples 1A to 6A were prepared by mixing the materials in the amounts shown in Table 7 below. The upper part of Table 7 shows weight amounts of each material used to prepare the light filter coating compositions. The lower part of Table 7 shows percentages of the dry extract amount of each material based on a dry extract weight of the base coating composition. Examples 1A, 4A, 5A, and 6A do not include a UV absorber, while Examples 2A and 3A include 0.10 g of a UV absorber.

### Comparative Example 1

A base coating composition of Comparative Example 1 was prepared by mixing the same materials as those used in Examples 2A and 3A, except that a smaller amount of the antioxidant and a greater amount of the UV absorber were used in Comparative Example 1.

TABLE 7

| | Exp 1A | Exp 2A | Exp 3A | Exp 4A | Exp 5A | Exp 6A | Comp 1 |
|---|---|---|---|---|---|---|---|
| Base coating | | | | | | | |
| composition (g) | | | | | | | |
| UVACURE 1500 | 6.64 | 6.64 | 6.64 | 6.64 | 5.98 | 6.32 | 6.64 |
| Erisys GE-31 | 2.84 | 2.84 | 2.84 | 2.84 | 1.58 | 1.58 | 2.84 |
| Erisys GE-60 | 0 | 0 | 0 | 0 | 3.38 | 0 | 0 |
| Glymo | 0 | 0 | 0 | 0 | 0 | 1.92 | 0 |
| Cyracure UVI-6976 | 0.35 | 0.35 | 0.35 | 0.35 | 0.39 | 0.30 | 0.35 |
| Cyracure UVI-6992 | 0.11 | 0.11 | 0.11 | 0.11 | 0.13 | 0.10 | 0.11 |
| Irganox 245 | 0.40 | 0.30 | 0.40 | 0.50 | 0.50 | 0.50 | 0.20 |
| Tinuvin 1130 | 0 | 0.10 | 0.10 | 0 | 0 | 0 | 0.20 |
| Dowanol PM | 10.02 | 10.02 | 10.02 | 10.02 | 8.48 | 9.74 | 10.02 |
| FC-4434 | 0.04 | 0.04 | 0.04 | 0.04 | 0.06 | 0.04 | 0.04 |
| Total | 20.4 | 20.4 | 20.5 | 20.5 | 20.5 | 20.5 | 20.40 |
| Dry coating | | | | | | | |
| composition (%) | | | | | | | |
| UVACURE 1500 | 65.61 | 65.61 | 64.97 | 64.97 | 51.05 | 63.37 | 65.61 |
| Erisys GE-31, | 28.06 | 28.06 | 27.79 | 27.79 | 42.34 | 29.51 | 28.06 |
| 60 & Glymo | | | | | | | |
| Photo-initiator | 2.27 | 2.27 | 2.25 | 2.25 | 2.22 | 2.01 | 2.27 |
| Irganox 245 | 3.95 | 2.96 | 3.91 | 4.89 | 4.27 | 5.01 | 1.98 |
| Tinuvin 1130 | 0 | 0.99 | 0.98 | 0 | 0 | 0 | 1.98 |
| FC-4434 | 0.10 | 0.10 | 0.10 | 0.10 | 0.13 | 0.10 | 0.10 |
| Total | 100 | 100 | 100 | 100 | 100 | 100 | 100 |

### (2) Preparation of Light Filter Coating Compositions

0.005 g of ABS420 or 0.01 g of Savinyl Blue (Solvent Blue 45) was added to each of the base coating compositions of Examples 1A to 6A and Comparative Example 1A. The resulted solutions were stirred for 30 minutes and then placed in an ultrasonic bath for 30 minutes. The coatings were filtered with a 0.2 μm capsule filter prior to use.

### (3) Formation of Light Filter Coatings

Microscope slides were cleaned by soap and water before the coating process. The base coating compositions mixed with an absorbing dye (ABS420 or Savinyl Blue) and filtered with the 0.2 μm capsule filter were coated on the clean slides through spin coating with the spin speeds of 300/600 rpm (10 s/5 s), roll-to-roll coating, or ink-jet printing process.

The coated slides were then placed on the belt of a UV Fusion system, at the speed of 5 ft/min (1.5 m/min). The fusion H+bulb had the following conditions:

UV dosage:

UV-A: 1.926 J/m², UV-B: 1.513 J/cm², UV-C: 0.327 J/cm², UV-V: 1.074 J/cm²

UV power:

UV-A: 1.121 W/m², UV-B: 0.850 W/cm², UV-C: 0.180 W/cm², UV-V: 0.602 W/cm².

The obtained dry coatings were at 10 to 20 μm of thickness.

### (4) Evaluations of Transmittance of Light Filter Coatings

The coated slides were submitted for Cary 60 measurements. Table 8 below summarizes the results:

TABLE 8

| Coating on glass slide | | Comp 1 | Exp 2A | Exp 3A | Exp 4A | Exp 5A | Exp 6A |
|---|---|---|---|---|---|---|---|
| After UV curing | | | | | | | |
| ABS420 | T %_{@λmax 423 nm} | 14.3 | 9.9 | 9.6 | 9.1 | 11.3 | 10.5 |
| Savinyl | T %_{@λmax 625 nm} | 60.9 | 56.7 | 56.1 | 55.6 | 59.5 | 57.4 |
| blue | | | | | | | |
| After Q-sun 40 h test | | | | | | | |
| ABS420 | T %_{@λmax 423 nm} | 35.2 | 26.1 | 20.9 | 17.6 | 26.3 | 21.4 |
| Savinyl | T %_{@λmax 625 nm} | 68 | 62.7 | 60.2 | 58.5 | 64.2 | 60.9 |
| blue | | | | | | | |
| ABS420 | P-D % | 27 | 19 | 14 | 10 | 18 | 13 |
| Savinyl | P-D % | 23 | 17 | 11 | 8 | 14 | 10 |
| blue | | | | | | | |

As shown in Table 8, the slides of Examples 2A to 6A showed lower transmittance intensity than the slide of Comparative Example 1. These results indicate that the slides of Examples 2A to 6A maintained the similar color to the initial coated ABS420 or Savinyl Blue slides without UV curing. Furthermore, the slides of Examples 2A to 6A showed lower photo-degradation in the Q-sun 40h test (P-D %<25) than the slide of Comparative Example 1.

### (5) Evaluations of Lens Performance

CR39 plano FSV lenses were caustic cleaned before the coating process. The base coating compositions mixed with an absorbing dye and filtered with the 0.2 μm capsule filter prepared in the step (2) above were spun on the convex side of each lens with the spin speeds of 600/1200 rpm (10 s/8 s), respectively.

The coated lenses were then placed on the belt of a UV Fusion system, at the speed of 5 ft/min (1.5 m/min). The Fusion H+bulb had the following conditions:

UV dosage:

UV-A: 1.926 J/m², UV-B: 1.513 J/cm², UV-C: 0.327 J/cm², UV-V: 1.074 J/cm²

UV power:

UV-A: 1.121 W/m², UV-B: 0.850 W/cm², UV-C: 0.180 W/cm², UV-V: 0.602 W/cm².

The obtained dry coatings were at 4 to 10 μm of thickness.

The coated lenses were then submitted for haze, Sand Bayer and Q-sun 80h adhesion measurements. The results are summarized in Table 9 below:

TABLE 9

| | Exp | Exp | Exp | Exp | Exp | Exp |
|---|---|---|---|---|---|---|
| Coating on CR39 | 1A | 2A | 3A | 4A | 5A | 6A |
| Thickness | 5.1 | 5.2 | 5.5 | 5.5 | 6.7 | 4.9 |
| Haze | 0.11 | 0.10 | 0.12 | 0.11 | 0.13 | 0.10 |
| Sand Bayer | 0.93 | 0.91 | 0.96 | 0.97 | 0.78 | 1.15 |
| Adhesion (0-80 h) | Pass | Pass | Pass | Pass | Pass | Pass |

As shown in Table 9, the lenses of Examples 1A to 6A presented all performances within the product specifications, as a functional primer coating for ophthalmic lens applications.

The following examples 1B to 10B relate to radiation curable compositions containing a blue light absorbing dye and an antioxidant, providing photo-stable hard coatings. The compositions were prepared in the same way as those of examples 1a to 6A.

| Solution (g) | Exp 1B | Exp 2B | Exp 3B | Exp 4B | Exp 5B | Exp 6B | Exp 7B | Exp 8B | Exp 9B | Exp 10B |
|---|---|---|---|---|---|---|---|---|---|---|
| Major epoxy | EP3F08.01 | Epalloy | EP0409 | EP3F08.01 | Epalloy | EP3F08.01 | EP3F08.01 | EP3F08.01 | Epalloy | EP0409 |
| | | 9000 | | | 9000 | | | | 9000 | |
| Glymo | 8.56 | 8.42 | 8.43 | 8.49 | 8.35 | 8.39 | 8.47 | 8.54 | 8.41 | 8.41 |
| GE-31 | 0.88 | 0.87 | 0.87 | 0.87 | 0.86 | 0.86 | 0.87 | 0.88 | 0.86 | 0.87 |
| Major epoxy | 3.92 | 2.92 | 2.72 | 3.88 | 2.90 | 3.84 | 3.88 | 3.91 | 2.92 | 2.72 |
| Irganox 245 | 0.56 | 0.55 | 0.72 | 0.72 | 0.71 | 0.48 | 0.44 | 0.39 | 0.38 | 0.45 |
| Tinuvin 1130 | 0 | 0 | 0 | 0 | 0 | 0.47 | 0.20 | 0.14 | 0.14 | 0.20 |
| Tinuvin 152 | 0 | 0 | 0 | 0 | 0 | 0 | 0.12 | 0.06 | 0.06 | 0.11 |
| Dowanol PM | 5.28 | 6.43 | 6.46 | 5.23 | 6.38 | 5.17 | 5.22 | 5.27 | 6.42 | 6.44 |
| UVI-6976 | 0.56 | 0.56 | 0.55 | 0.56 | 0.56 | 0.55 | 0.55 | 0.56 | 0.56 | 0.55 |
| UVI-6992 | 0.19 | 0.19 | 0.19 | 0.19 | 0.19 | 0.18 | 0.19 | 0.19 | 0.19 | 0.18 |
| FC-4434 | 0.07 | 0.06 | 0.07 | 0.07 | 0.06 | 0.06 | 0.07 | 0.07 | 0.06 | 0.07 |
| Total | 20.00 | 20.00 | 20.00 | 20.00 | 20.00 | 20.00 | 20.00 | 20.00 | 20.00 | 20.00 |

| Dry comp.(%) | Exp 1 | Exp 2 | Exp 3 | Exp 4 | Exp 5 | Exp 6 | Exp 7 | Exp 8 | Exp 9 | Exp 10 |
|---|---|---|---|---|---|---|---|---|---|---|
| Glymo | 57.86 | 56.65 | 56.82 | 56.98 | 55.80 | 55.75 | 56.77 | 57.69 | 56.49 | 56.60 |
| GE31 | 8.09 | 7.94 | 7.98 | 7.96 | 7.82 | 7.79 | 7.93 | 8.06 | 7.92 | 7.95 |
| Major epoxy | 25.29 | 26.80 | 25.03 | 24.91 | 26.40 | 24.37 | 24.81 | 25.22 | 26.72 | 24.94 |
| monomer | | | | | | | | | | |
| Irganox 245 | 5.15 | 5.05 | 6.62 | 6.59 | 6.47 | 4.35 | 4.02 | 3.59 | 3.48 | 4.13 |
| Tinuvin 1130 | 0 | 0 | 0 | 0 | 0 | 4.26 | 1.83 | 1.29 | 1.28 | 1.84 |
| Tinuvin 152 | 0 | 0 | 0 | 0 | 0 | 0 | 1.10 | 0.55 | 0.55 | 1.01 |
| Photo-initiator | 3.45 | 3.43 | 3.40 | 3.40 | 3.37 | 3.33 | 3.39 | 3.44 | 3.42 | 3.38 |
| FC-4434 | 0.15 | 0.14 | 0.15 | 0.15 | 0.14 | 0.15 | 0.15 | 0.15 | 0.14 | 0.15 |
| Total | 100 | 100 | 100 | 100 | 100 | 100 | 100 | 100 | 100 | 100 |

ABS420 or Savinyl Blue (Solvent Blue 45) dyes were mixed into 20 g of each of the above resulted solutions, at 0.05 and 0.2 wt %, respectively. The coating solutions and coated lenses were prepared in the same way as previously described. 5.5 to 6.5 μm thick coatings were obtained.

| Example | 1B | 2B | 3B | 4B | 5B | 6B | 7B | 8B | 9B | 10B |
|---|---|---|---|---|---|---|---|---|---|---|
| Haze % | 0.11 | 0.08 | 0.10 | 0.11 | 0.10 | 0.14 | 0.09 | 0.10 | 0.11 | 0.12 |
| Sand Bayer | 2.3 | 2.0 | 2.3 | 2.2 | 1.9 | 2.1 | 2.0 | 2.4 | 2.0 | 2.3 |
| Adhesion (0-80 h) | Pass | Pass | Pass | Pass | Pass | Pass | Pass | Pass | Pass | Pass |

Photo-degradation % after 40 h of Q-sun exposure

| | | | | | | | | | | |
|---|---|---|---|---|---|---|---|---|---|---|
| ABS420_{423 nm} | 23 | 19 | 24 | 18 | 14 | 23 | 5 | 12 | 10 | 16 |
| Savinyl Blue_{625 nm} | 20 | 17 | 19 | 15 | 13 | 22 | 11 | 19 | 15 | 21 |

It was observed that the use of an antioxidant effectively improves the dye/coating photo-stability. In its absence, photo-degradation % of the dyes after 40h of Q-sun exposure is generally above 75%.

In summary, the present disclosure pertains in some embodiments to an optical article, wherein the optical article comprises: at least one surface; and at least one functional coating, wherein the functional coating is at least partially in contact with the at least one surface, wherein the coating comprises: at least one light absorber; at least one photoinitiator; and the at least one UV curable resin comprises at least one resin selected from the group consisting of an acrylic resin, an epoxy resin, and mixtures thereof. The functional coating has a thickness gradient across the at least one surface of the optical article. The at least one photoinitator is selected from the group consisting of aromatic onium salts, iron arene salt complexes, benzophenone, acetophenone compounds, and combinations thereof. The at least one resin is selected from the group consisting of mono-to hexaacrylate monomers, mono-to diacrylate oligomers, cycloaliphatic epoxies, mono-to polyglycidylether epoxies, and combinations thereof.

The present disclosure provides three types of coating formulations, for plastic substrates, and ophthalmic lenses, in particular. Specifically, a pure free radical cure acrylic formulation, and a pure cationic cure epoxy formulation, and a hybrid free radical and cationic formulation. Examples of these three different chemistries were optimized to meet all of the performance criteria. The coating compositions are sufficiently cured to exhibit robust adhesion to the substrate, therefore capable of withstanding subsequent treatments and coatings.

The claims are not to be interpreted as including means-plus- or step-plus-function limitations, unless such a limitation explicitly recited in a given claim using the phrase(s) “means for” or “step for,” respectively.

1. A radiation curable coating composition comprising:
at least one light absorber;
at least one UV curable resin; and
at least one photoinitiator,
wherein the at least one UV curable resin comprises at least one resin selected from the group consisting of an acrylic resin, an epoxy resin, and mixtures thereof.

2. The coating composition of claim 1, wherein the at least one photoinitiator is selected from the group consisting of aromatic onium salts, iron arene salt complexes, benzophenone, acetophenone compounds, and combinations thereof.

3. The coating composition of claim 1, wherein the at least one resin is selected from the group consisting of mono to hexaacrylate monomers, mono to diacrylate oligomers, cycloaliphatic epoxy compounds, mono to polyglycidylether epoxy compounds, and combinations thereof.

4. The coating composition of claim 1, wherein the at least one resin is an epoxy resin, and wherein the epoxy resin is the sole resin of the at least one UV curable resin.

5. The coating composition of claim 1, wherein the at least one resin is a mixture of the acrylic resin, the epoxy resin, and wherein the mixture is the sole resin of the at least one UV curable resin.

6. The coating composition of claim 1, further comprising at least one antioxidant.

7. The coating composition of claim 1, wherein the light absorber is an absorbing dye that has a conjugated chromophore and at least partially inhibits transmission of light in at least one selected wavelength range included within the 380-780 nm wavelength range.

8. The coating composition of claim 1, further comprising at least one epoxy compound bearing at least one silicon atom having at least one hydrolyzable group directly linked to the silicon atom and at least one group comprising an epoxy function linked to the silicon atom though a carbon atom, and/or a hydrolyzate thereof.

9. The coating composition of claim 1, wherein the at least one resin is at least one epoxy monomer having two or three epoxy groups, which is not a silicon compound having at least one hydrolyzable group directly linked to the silicon atom.

10. The coating composition of claim 1, comprising:
(a) at least one epoxy monomer having two or three epoxy groups, which is not a silicon compound having at least one hydrolyzable group directly linked to the silicon atom,
(b) optionally, at least one epoxy compound bearing at least one silicon atom having at least one hydrolyzable group directly linked to the silicon atom and at least one group comprising an epoxy function linked to the silicon atom though a carbon atom, and/or a hydrolyzate thereof,
(c) at least one photoinitiator,
(d) at least one absorbing dye that at least partially inhibits transmission of light in at least one selected wavelength range included within the 380-780 nm wavelength range, and
(e) at least one antioxidant.

11. The coating composition of claim 1, comprising:
(a) at least one epoxy monomer having at least three epoxy groups, which is not a silicon compound having at least one hydrolyzable group directly linked to the silicon atom,
(b) at least one epoxy compound bearing at least one silicon atom having at least one hydrolyzable group directly linked to the silicon atom and at least one group comprising an epoxy function linked to the silicon atom though a carbon atom, and/or a hydrolyzate thereof,
(c) at least one photoinitiator,
(d) at least one absorbing dye that has a conjugated chromophore and at least partially inhibits transmission of light in at least one selected wavelength range included within the 380-780 nm wavelength range, and
(e) at least one antioxidant,
wherein the composition does not comprise any epoxy monomer having two epoxy groups, which is not a silicon compound having at least one hydrolyzable group directly linked to the silicon atom.

12. The coating composition of claim 11, wherein compounds (b) represent more than 50% by weight as compared to the total weight of polymerizable compounds present in the composition.

13. A method for coating an optical article with a functional coating, wherein the method comprises:
a) providing an optical article, wherein the optical article comprises a substrate having at least one surface;
b) providing a radiation curable coating composition comprising at least one light absorber, at least one UV curable resin, and at least one photoinitiator, wherein the at least one UV curable resin comprises at least one resin selected from the group consisting of an acrylic resin, an epoxy resin, and mixtures thereof;
c) applying the radiation curable coating composition to at least a portion of the at least one surface of the optical article substrate;
d) UV curing the coating applied to the at least one surface of the optical article substrate; and
e) cleaning and preparing the coated surface of the optical article substrate for further treatment.

14. The method of claim 13, wherein the step of providing an optical article further comprises providing an optical article, wherein the optical article comprises a substrate having a first surface and a second surface opposed to the first surface.

15. The method of claim 14, wherein the step of applying the coating further comprises applying the coating composition to at least a portion of the first surface and at least a portion of the second surface.

16. The method of claim 13, wherein the step of applying further comprises applying the coating composition by at least one process selected from dip-coating, spin-coating, and inkj et-coating.

17. An optical article, wherein the optical article comprises:
at least one surface; and
at least one functional coating, wherein the functional coating is at least partially in contact with the at least one surface, wherein the coating comprises:
at least one light absorber;
at least one photoinitiator; and
the at least one UV curable resin comprises at least one resin selected from the group consisting of an acrylic resin, an epoxy resin, and mixtures thereof.

18. The optical article of claim 17, wherein the coating has a thickness gradient across the at least one surface of the optical article.

19. The optical article of claim 17, wherein the at least one resin is selected from the group consisting of mono to hexaacrylate monomers, mono to diacrylate oligomers, cycloaliphatic epoxy compounds, mono to polyglycidylether epoxy compounds, and combinations thereof.
